(19) United States
(12) Patent Application Publication
(10) Pub. No.: US 2010/0243701 A1
(43) Pub. Date: Sep. 30, 2010

(54) Lever Stapler

(76) Inventor: Bin Yu, Shenzhen (CN)

Correspondence Address: Jackson Intellectual Property Group PLLC, 106 Starvale Lane, Shipman, VA, 22971, US

(21) Appl. No.: 12/208,948

(22) Filed: Sep. 11, 2008

(30) Foreign Application Priority Data
Oct. 31, 2006 (CN) 200620015544.6
Dec. 18, 2006 (CN) PCT/CN2006/003455

(51) Int. Cl. B25C 5/11

(52) U.S. Cl. 227/129

(57) ABSTRACT

A lever stapler includes a plastic cover, a pressure plate, a stapling bracket, a staple cartridge, a staple slot, a staple driver, a staple driving shaft, a staple driving spring, a staple plate, a support stand, a base, and a rotating shaft. The pressure plate includes a lever pressing plate disposed thereon, and a rear end of the lever pressing plate is hinged onto the support stand through a fulcrum shaft, and the lever pressing plate further includes a lever shaft contacted with the top of the pressure plate. The lever stapler of the invention enhances the stapling force to achieve the effects of reducing the required force for the stapling and stapling a thick document easily.

### BACKGROUND OF THE INVENTION

(a) Field of the Invention

The present invention relates to a stapler, and more particularly to a lever stapler.

(b) Description of the Related Art

In general, a conventional stapler is composed of basic parts including a base, a bumper, a staple cartridge, and a pressing cover. In the principle of operating the conventional stapler, a user presses the upper cover by a hand to exert a force onto a staple in the staple cartridge that operates together with the bumper to complete a stapling job. The stapling process of the stapler of this sort totally relies on a direct force from the user's hand and also requires a relatively larger action force and a longer time, and thus causing tiredness to the user's hand easily. If the action force of the user's hand is smaller than the required pressure for stapling a thick document, the stapler may be bent in an unexpected way that affects the stapling effect or the stapler cannot be punched through the paper at all.

### SUMMARY OF THE INVENTION

It is a primary objective of the present invention to overcome the shortcomings of the prior art by providing a lever stapler with a lever pressing plate connected to the bumper to increase the stapling force significantly under the same condition of action force, so as to overcome the existing problem of the prior art having an insufficient stapling force.

To achieve the foregoing objective, the present invention provides a stapler comprising a plastic cover, a pressure plate, a stapling bracket, a staple cartridge, a staple slot, a staple driver, a staple driving shaft, a staple driving spring, a staple plate, a support stand, a base, and a rotating shaft, wherein the top of the pressure plate includes a lever pressing plate, and a rear end of the lever pressing plate is hinged onto the support stand through a fulcrum shaft, and the lever pressing plate also includes a lever shaft contacted with the top of the pressure plate.

The present invention further comprises a spring installed between the staple cartridge and the pressure plate and a base spring installed between the base and the staple cartridge.

The plastic cover is covered onto the exterior of the lever pressing plate, and rear ends of the pressure plate and the staple cartridge are mounted onto the support stand through the rotating shaft, and a lower end of the support stand is fixed onto the base.

With the foregoing elements, the present invention can achieve the effect of connecting a lever pressing plate onto the top of the pressure plate to save efforts and provide a simple structure for an excellent and convenient stapling effect.

### BRIEF DESCRIPTION OF THE DRAWINGS

FIG. 1 is a schematic view of an overall structure of the present invention; and

FIG. 2 is a schematic view of a lever pressing plate assembly of FIG. 1.

The elements corresponding to their respective numerals indicated in the figures are listed as follows: plastic cover 1, pressure plate 2, bracket rivet 3, stapling bracket 4, staple cartridge 5, staple slot 6, staple driver 7, staple driving shaft 8, staple plate 9, staple plate rivet spring 10, bumper rivet 11, plastic bottom 12, staple driving spring 13, base spring 14, support stand 15, metal base 16, rotating shaft 17, staple slot latch 18, staple slot latch spring 19, staple slot latch handle 20, brake protrusion 21, fulcrum shaft 22, spring 23, lever pressing plate 24, and lever shaft 25.

### DETAILED DESCRIPTION OF THE PREFERRED EMBODIMENT

The present invention is illustrated in details by the description of a preferred embodiment together with its related drawings as follows.

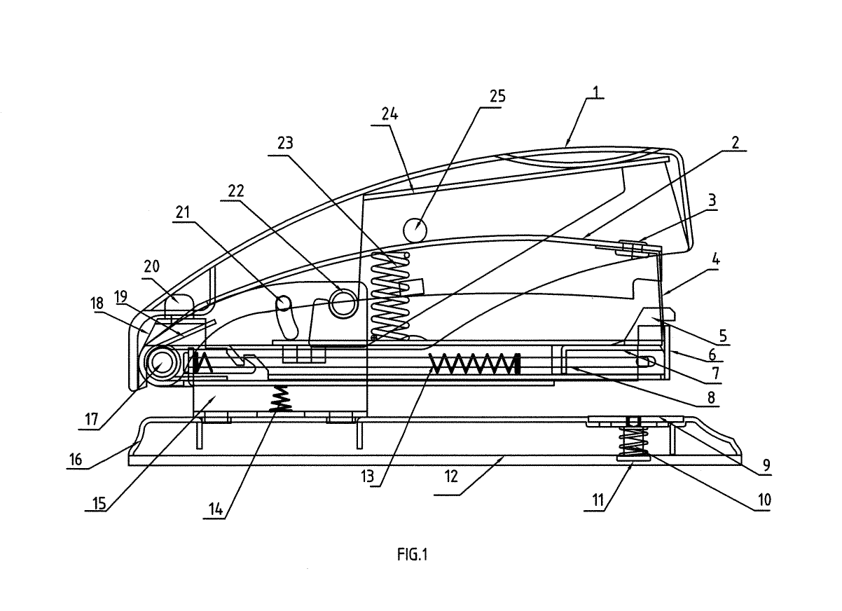

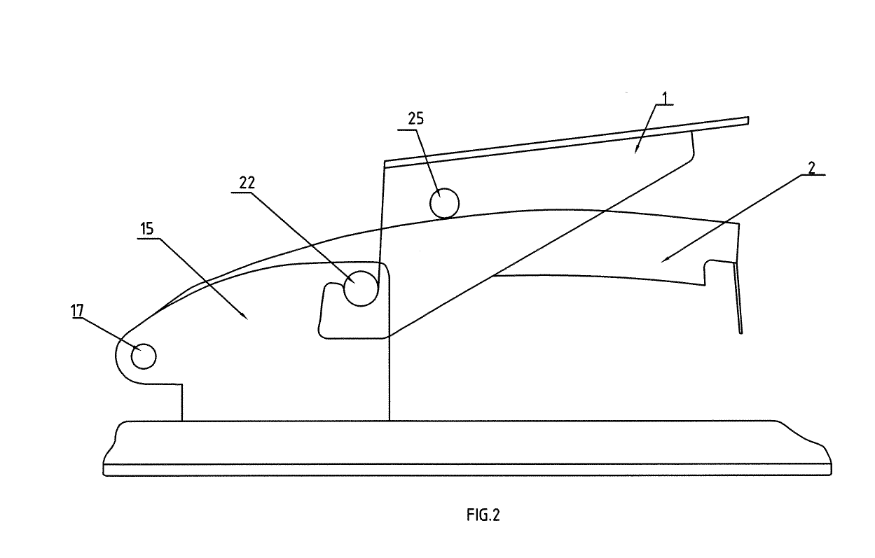

In FIGS. 1 and 2, the objective of the lever stapler in accordance with the invention is to enhance the stapling force to reduce external required force for the stapling.

In the stapler in accordance with the invention, a base module is connected to a stapling containing module and a stapling module through a rotating shaft 15, such that an action force of a stapling bracket 4 of the stapling module drives and presses a staple from a staple slot 6 of the staple containing module onto a staple plate 9 of the base module for binding documents.

The base module comprises a metal base 16, a plastic bottom 12, a support stand 15, a staple plate 9, a staple plate rivet 11, a staple plate rivet spring 10 and a base spring 14. The plastic bottom 12 is connected through six legs of the metal base 16, and the staple plate 9 is fixed to the metal base 16 by the staple plate rivet 11 under the action of the staple plate rivet spring 10 for changing a direction of rotation, and the support stand 15 is fixed through two holes of the support stand 15, and the metal base 16 is integrally coupled with the rotating shaft 17 through the two holes of the support stand 15.

The stapling module comprises a staple cartridge 5, a staple slot 6, a staple driver 7, a staple driving spring 13, a staple driving shaft 8, a staple slot latch 18, a staple slot latch handle 20 and a staple slot latch spring 19. The staple slot 6 can slide back and forth in the staple cartridge 5, and staples are placed in the staple slot 6. With the action force of the staple driver 7 exerted onto the staple driving shaft 8 and the staple driving spring 13, the staple can be driven from the staple slot 6 into a staple outlet of the staple slot. An action force of the staple slot latch spring 19 is exerted onto the staple slot latch 18, and the staple slot latch spring is rotated with respect to the rotating shaft 17 and operated together with the staple slot 6 for controlling the slide of the staple slot 6 to achieve the stapling effect. The stapling module is connected to the base module through the rotating shaft 17. With the action of the base spring 14, the stapling module is swung up and down by using the rotating shaft 17 as a center.

The stapling module further comprises a plastic cover 1, a lever pressing plate 24, a pressure plate 2, a stapling bracket 4, a bracket rivet 3, a lever shaft 25 and a spring 23. The stapling bracket 4 is fixed onto the pressure plate 2 by the rivet 3, and two holes at an end of the pressure plate are connected with the rotating shaft 17 under the action of the spring 23 to rotate in a specific angle along the rotating shaft 17, and the lever shaft 25 is fixed onto the lever pressing plate 24. A fulcrum shaft 22 on the support stand 15 pushes the pressure plate 2 to rotate concentrically with the rotating shaft 17, and the plastic cover 1 is fixed onto the lever pressing plate 24 for controlling the position of the lever pressing plate 24 under the action of a brake protrusion 21 on the support stand 15.

I claim,

1. A lever stapler, comprising, a plastic cover, a pressure plate, a stapling bracket, a staple cartridge, a staple slot, a staple driver, a staple driving shaft, a staple driving spring, a staple plate, a support stand, a base, and a rotating shaft, characterized in that said pressure plate includes a lever pressing plate disposed thereon, and a rear end of said lever pressing plate is hinged onto said support stand through a fulcrum shaft, and said lever pressing plate further includes a lever shaft contacted with the top of said pressure plate.

2. The lever stapler of claim 1, further comprising a spring installed between said staple cartridge and said pressure plate.

3. The lever stapler of claim 1, further comprising a base spring installed between said base and the bottom of said staple cartridge.

4. The lever stapler of claim 1, wherein said plastic cover is covered onto the exterior of said lever pressing plate, and rear ends of said pressure plate and said staple cartridge are fixed onto said support stand through said rotating shaft, and a lower end of said support stand is fixed onto said base.
